(19) United States
(12) Patent Application Publication
(10) Pub. No.: US 2009/0099693 A1
(43) Pub. Date: Apr. 16, 2009

(54) SYSTEM AND METHOD FOR CONTROL OF EMOTIONAL ACTION EXPRESSION

(75) Inventors: Sang Seung Kang, Daejeon (KR); Jae Hong Kim, Daejeon (KR); Joo Chan Sohn, Daejeon (KR); Hyun Kyu Cho, Daejeon (KR); Young Jo Cho, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/207,714

(22) Filed: Sep. 10, 2008

(30) Foreign Application Priority Data
Oct. 16, 2007 (KR) 10-2007-0104133

(51) Int. Cl. G05B 15/00

(52) U.S. Cl. 700/258; 901/46

(57) ABSTRACT

A system for control of emotional action expression including an emotion engine for creating an emotion according to information provided from a plurality of sensors, and an emotional action expression/actuation control unit for detecting an emotion platform profile and an emotion property from the created emotion and determining the action expression corresponding to the created emotion to control a target actuator. A control unit controls the motion of the target actuator under the control of the emotional action expression/actuation control unit.

### CROSS-REFERENCE(S) TO RELATED APPLICATIONS

The present invention claims priority of Korean Patent Application No. 10-2007-0104133, filed on Oct. 16, 2007, which is incorporated herein by reference.

### FIELD OF THE INVENTION

The present invention generally relates to an emotion system and, more particularly, to a method and system for control of emotional action expression of a robot capable of defining a specific emotional action from emotion information input by the robot and controlling a target actuator to express the defined emotional action.

This work was supported by the IT R&D program of MIC/IITA [2006-S-026-02, Development of the URC Server Framework for Protective Robotic Services].

### BACKGROUND OF THE INVENTION

In recent years, studies on emotion systems for creating an emotion model using instructions of a user, or surrounding environment information and sensor information and controlling the operation of a robot based on the created emotion model.

Such systems for creating an emotion or expressing a selected action using information of various sensors such as vision sensors, audition sensors, and tactile sensors are being developed as pet robots or intelligent robots. In addition, studies on improvement in functions of emotion engines and their related systems for more natural action expressions are being continuously carried out based on emotions that are personified or reflect on animal actions.

Furthermore, efforts for recognizing an intention of a user for natural interactions between a person and a robot are being made together with improvement in functions of a sensor unit for detection of change in input by the user and change in state, and various studies on actuator technology for expression of natural actions in hardware actuators of a robot are being carried out.

Meanwhile, it is important to develop both hardware actuators and internal systems for control of the hardware actuators in order to enable expression of faithful expression based on emotion information. In particular, it is necessary to develop an emotional action expression system that is not dependent on a specific robot or system but independently manageable. However, an independently manageable emotional action expression system has not been yet developed.

Therefore, in order to naturally and realistically actuate a hardware-based actuator according to situation and emotion, it is necessary to develop an emotional action expression system manageable independently from robot systems by organically controlling physical actuators and internal systems for actuation and management of the physical actuators.

### SUMMARY OF THE INVENTION

It is, therefore, an object of the present invention to provide a method and system for control of emotional action expression of a robot capable of detecting an emotion platform profile and an emotion property from input emotion information created in an emotion engine, determining suitable action expression with reference to an action map, selecting a target actuator according to the action expression, and analyzing a control command and determining control type to enable control of the target actuator.

Another object of the present invention is to provide a method and system for control of emotional action expression of a robot that enables expression of a natural action that is independently manageable in an emotion system and suitable for a created emotion by providing a method for directly controlling internal resources of an embedded system and a method for controlling an actuator by creating a control message to control external resources.

In accordance with an exemplary embodiment of the present invention, there is provided a system for control of emotional action expression of a robot including:

an emotion engine for creating an emotion of the robot according to information provided from a plurality of sensors;

an emotional action expression/actuation control unit for detecting an emotion platform profile and an emotion property from the created emotion and determining the action expression of the robot corresponding to the created emotion to control a target actuator of the robot; and

a control unit for controlling the motion of the target actuator under the control of the emotional action expression/actuation control unit.

In accordance with another exemplary embodiment of the present invention, there is provided a method for control of emotional action expression of a robot including:

extracting characteristic information and creating emotion information of the robot with respect to an internal or external stimulus applied to the robot using a plurality of sensors;

detecting an emotion platform profile and an emotion property and referring to an action map, in response to the emotion information;

determining action expression corresponding to the emotion information;

selecting a target actuator expressing the motion of the robot depending on the action expression and determining control type of the target actuator;

controlling the motion of the target actuator according to the determined control type; and

expressing the emotion of the robot provided from the emotion engine.

Accordingly, the present invention provides a structuralized technology for expression of an emotion action and control of a target actuator based on an embedded system and a technology manageable independently from a device unlike a conventional method for determining action expression from a created emotion, by providing an actuator control method for determining expression of an emotion action suitable for an emotion created in association with an emotion engine and efficiently expressing an emotional action expression based on the determined action expression, in an emotion system that gives a person emotional familiarity through expression of various actions based on a self-controlled emotion.

Furthermore, the present invention enables optimization of an interaction between a person and a robot based on an emotion, by expression of a natural emotion action suitable for change in emotion in an emotion system such as an emotion robot and an intelligent robot through a hardware-based device for expression of a faithful emotion, an internal system for control of the hardware-based device, and a technology for organic connection between them. In particular, the present invention enables reduction of the weight of an entire system and transplantation to a specific emotion system as well as another emotion system, by configuring an embedded system with a library or an application program interface module for expression and control of emotion action in association with an emotion engine based on an embedded operating system.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a system for control of emotional action expression of a robot in accordance with an embodiment of the present invention;

FIG. 2 is a block diagram of the emotional action expression/actuation control unit 300 shown in FIG. 1;

FIG. 3 is a view illustrating functional relations for determination of the action expression depending on the emotion information in accordance with the embodiment of the present invention;

FIG. 4 is a view illustrating functional relations for calling the internal resources or controlling external hardware units according to the determined action expression by the action expresser 320 shown in FIG. 2; and

FIG. 5 is a flowchart illustrating a process of expressing an emotion action according to emotion information and controlling an actuator in accordance with an embodiment of the present invention.

### DETAILED DESCRIPTION OF THE EMBODIMENTS

Hereinafter, embodiments of the present invention will be described in detail with reference to the accompanying drawings.

In summary, the present invention provides a structuralized technology for expression of an emotion action and control of an actuator based on an embedded system and a technology manageable independently from a device unlike a conventional technology for determining action expression from a created emotion, provides an actuator control method for determining emotional action expression suitable for an emotion created in association with an emotion engine and efficiently expressing an emotional action expression based on the determined action expression, in an emotion system that gives a person emotional familiarity through expression of various behaviors based on a autonomous emotion.

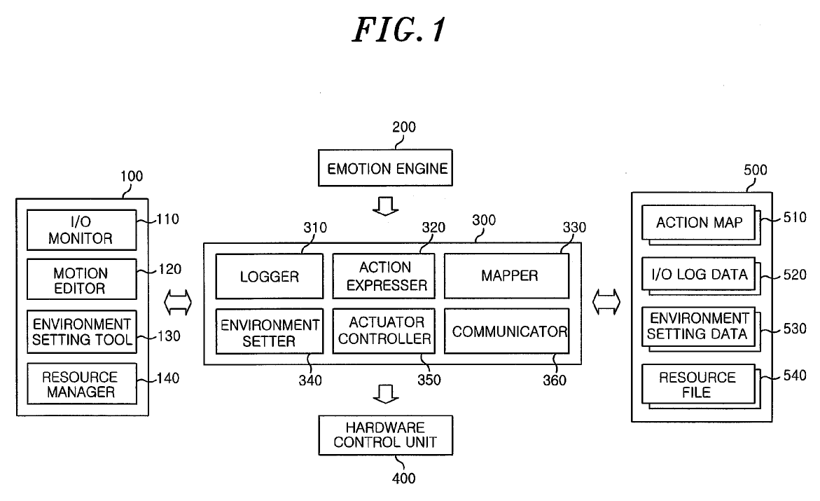

FIG. 1 is a block diagram illustrating a system for control of emotional action expression of a robot in accordance with an embodiment of the present invention.

Referring to FIG. 1, the system for control of emotional action expression of a robot in accordance with the present invention includes an external management unit 100 having a tool for carrying out monitoring and debugging of expression of the robot, a tool for creating and editing a motion and an action, and a tool for setting environment or managing resources. In addition, the system further includes an emotion engine 200 extracting characteristic information by sensor data detected from an internal or external stimulus applied to the robot, converting the sensor value, and creating an emotion of the robot, an emotional action expression/actuation control unit 300 controlling an actuator of the robot pursuant to information about the created emotion of the robot, determining suitable action expression of the robot, controlling internal resources or creating control messages, a hardware control unit 400 controlling motion of a mechanism through drive of a motor based on the created control messages, and a management resource unit 500 having an action map, log data, and an environment data, and a resource file.

The external management unit 100 includes an I/O monitor 110 confirming input/output information and providing a debugging function if necessary, a motion editor 120 creating and editing a motion and an action, an environment setting tool 130 setting a system environment, and a resource manager 140 managing resources. The external management unit 100 may additionally employ units for managing the emotional action expression/actuation control unit 300 more efficiently.

The emotional action expression/actuation control unit 300 is an embedded system for expressing and controlling emotion action in association with an emotion engine based on an embedded operating system, and includes a library or an application program interface. In detail, the emotional action expression/actuation control unit 300 includes a logger 310 storing the input/output information and an input/output state, an action expresser 320 determining the action expression, a mapper 330 providing mapping information, an environment setter 340 loading and referring to environment setting information of the system, and an actuator controller 350 controlling an actuator using an action expression, and a communicator 360 supporting communication environment with the emotion engine 200, a hardware control unit 400, and the external management unit 100.

The management resource unit 500 includes an action map 510 providing mapping information including emotion based behavior information, the action expression and a control command, I/O log data 520 including important information created in an input/output process, environment setting data 530 including the environment setting information, and a resource file 540 including an action file and an action script that enable expression and execution of actions in units of files, and a sound file for expressing sound effects and voice information.

The management resource unit 500 may manage all resources necessary to for supporting cooperation between the external management unit 100 and the emotional action expression and actuation control unit 300 and efficiently providing and administering the system environment information and required information.

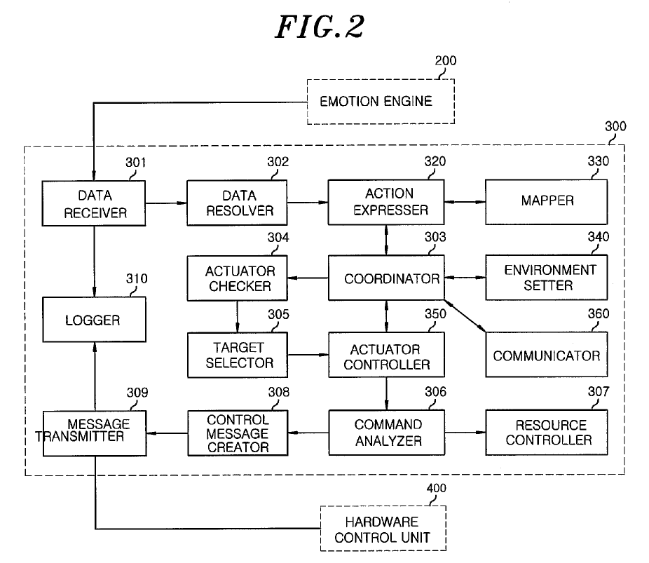

FIG. 2 is a block diagram of the emotional action expression/actuation control unit 300 shown in FIG. 1.

As illustrated in FIG. 2, the emotional action expression/actuation control unit 300 includes a data receiver 301 receiving emotion information including an emotion state and an emotion intensity from the emotion engine 200, a data resolver 302 detecting an emotion platform profile and an emotion property, a mapper 330 providing a mapping function based on the action amp, and an action expresser 320 determining an action expression based on the emotion platform the profile, the emotion property, and the mapping information, and a coordinator 303 organically interlocking the action expresser 320 and the actuator controller 350.

In addition, the emotional action expression/actuation control unit 300 includes an environment setter 340 loading and referring to the environment setting information, a communicator 360 supporting the communication environment, an actuator checker 304 initializing the actuator or checking the state of the actuators, a target selector 305 selecting one or more actuators depending on the action expression, an actuator controller 350 controlling the actuators, a command analyzer 306 analyzing a control command from the actuator controller 350 and determining a control type of the control command, a resource controller 307 checking the internal resources and calling or executing the system using the internal resources, a control message creator 308 creating control messages to be transmitted to an external control board, a message transmitter 309 transmitting the control messages, and a logger 310 logging and managing the emotion information and the control command.

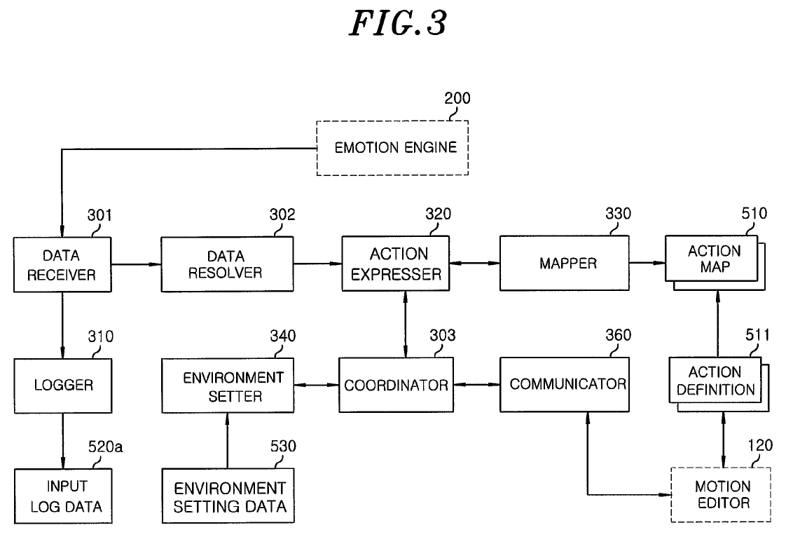

FIG. 3 is a view illustrating functional relations for determination of the action expression depending on the emotion information in accordance with the embodiment of the present invention.

As illustrated in FIG. 3, the data receiver 301 functions to receive the emotion information including the emotion state and the emotion intensity from the emotion engine 200, and the logger 310 performs a logging function of recording the emotion information. Then, the recorded log data 520a includes the emotion information and time stamp information thereof and a hash value for safe storage and management.

Then, the data resolver 302 performs a data resolving function of loading the emotion platform profile and detecting the emotion property from the received emotion information. In this case, the emotion platform profile includes information about the actuators of the emotional action expression control system such as a robot for the emotional action expression and information about specifically actuated ranges of the actuators and the control type of the control command. An emotion property includes information about the emotion state, and the emotion intensity or an emotion index, and may include single or complex emotion relation information and basic emotion behavior information.

Then, the action expresser 320 performs an action expression function of determining the action expression based on information about the emotion platform profile, the emotion property, and the mapping information, and is closely connected to the mapper 330 which provides a mapping function based on the action map 510. In this regard, the action map 510 includes information about emotion steps depending on the emotion intensity, basic behavior according to emotion, a human-readable action expression, an action transition and the like, and is based on a action definition 511 as shown in FIG. 3. The action map 510 created based on the definition of an action may be managed through a motion editor 120 or a separate application program.

The determined action expression information is transferred to the actuator controller 350 through the coordinator 303. In this regard, the coordinator 303 organically associates the action expression and the operation of the actuator controller 350, performs a communication function between the environment setter 340 loading, analyzing, and applying the environment setting data 530 and the motion editor 120, and supports communication between internal and external systems through the communicator 360.

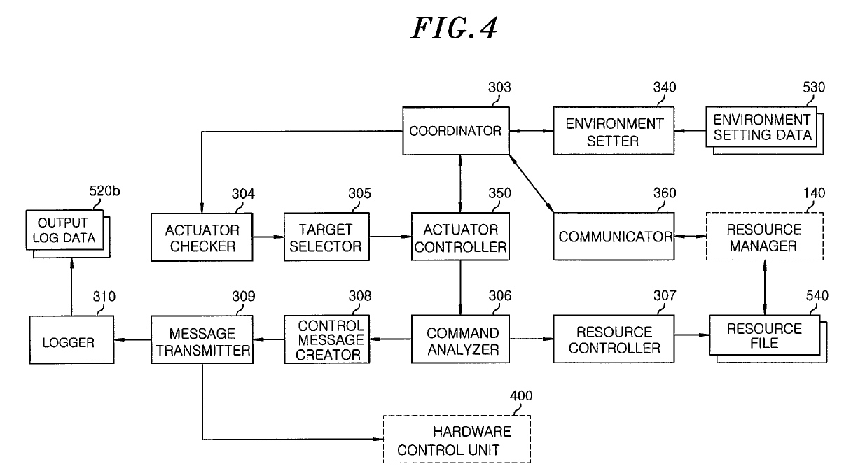

FIG. 4 is a view illustrating functional relations for calling the internal resources or controlling external hardware units according to the determined action expression by the action expresser 320.

As illustrated in FIG. 4, the determined action expression is transferred to the actuator controller 350 through the coordinator function of the coordinator 303 for organically associating the action expresser 320 and the actuator controller 350. As described above, the coordinator 303 refers to the environment setter 340 loading, analyzing, and applying the environment setting data 530 and the motion editor 120, and supports the communication between the internal and external systems to communicate with the resource manager 140 through the communicator 360.

Then, the actuator checker 304 performs an actuator checking function of initializing the actuators and checking states of the actuators, and the target selector 305 selects one or more actuators depending on the determined action expression. The actuator controller 350 performing a main function of controlling the actuator is connected to the coordinator 303 and maps the control command about the selected actuators.

Then, the command analyzer 306 performs a command analyzing function of analyzing the control command and determining the control type according to the type of the control command. If the control command is a command for a direct control, the resource controller 307 checks an internal resource, and performs a resource control function of calling and executing the system using the internal resources in response to the direct control command.

On the contrary, in the case of a control command for execution using the external resources, the control message creator 308 performs a control message creating function of creating a control message that is to be sent to the external control board, a message transmitter 309 transfers the control message to the hardware controller 400 through a message transmitting function, and at the same time, the logger 310 performs a logging function of recording output information.

Then, the recorded log data 520b performed by the logger 310 includes information on the control command and the time stamp information and includes a hash value for secure storage and management of the information. The control message is created suitably for a predetermined message standard according to the type of the control command, and includes message start information, target actuator ID information, control type and message type information, message content information, and error proof information.

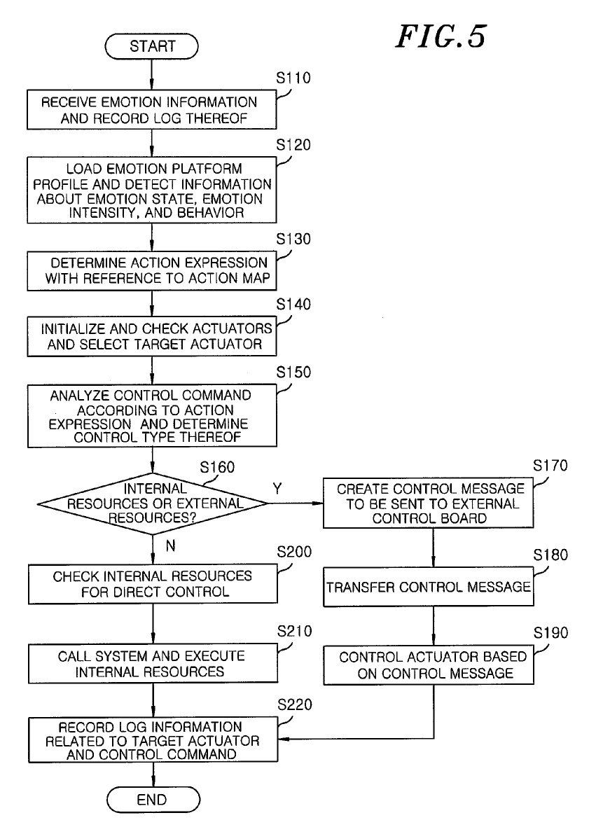

FIG. 5 is a flowchart illustrating a process of expressing an emotion action according to the emotion information and controlling an actuator in accordance with an embodiment of the present invention. Hereinafter, the embodiment of the present invention will be described in detail with reference to FIGS. 1 to 5.

As illustrated in FIG. 5, in the emotion action expression control system, the emotional action expression/actuation controller 300 receives the emotion information created by the emotion engine 200 is provided to the emotional action expression/actuation controller 300 and recorded in an input log in step S110.

Thereafter, the emotional action expression/actuation controller 300 loads the emotion platform profile and detects the emotion information including the emotion state, the emotion intensity, and the action, in step S120, and determines suitable action expression with reference to the detected information and the action map, in step S130.

Then, the emotional action expression/actuation controller 300 initializes and checks the actuators and selects a target actuator, in step S140, and analyzes the control command for controlling the target actuator according to the action expression and determines the control type of the control command.

Subsequently, in step S160, it is determined that the external resources are employed to control the actuators. If it is determined that the external resources, e.g., motors and the like, are employed to perform the action expression, a control process goes to steps S170 to S190 for execution of the external resources. On the other hand, if it is determined that only the internal resources, e.g., internal sound cards and the like, are employed to perform the action expression, a control process advances to steps S200 to S220 for execution of the internal resources.

Alternatively, in case of control of a complex actuator, the execution of the external resources and the execution of the internal resources are simultaneously executed to utilize both the resources. In case of a flow for execution of the external resources, a control message that is to be sent to an external control board, i.e., the hardware controller 400 located outside the system, is created, in step S170, and is transferred to the hardware controller 400 through a message communication protocol in step S180. The actuator is then controlled through the hardware controller 400 based on the control message, in step S190.

On the other hand, in case of a flow for execution of the internal resources, the internal resources to be directly controlled in the system is detected, in step S200, and the system is called or the detected internal resources are controlled through a module for execution of the internal resources, in step S210. Then, the execution of the internal resources and the external resources may be simultaneously or selectively carried out.

The control process is completed by carrying out the execution of the control command and recording information about a target actuator and log information about the control command, in step S220.

While the invention has been shown and described with respect to the exemplary embodiments, it will be understood by those skilled in the art that various changes and modifications may be made without departing from the scope of the invention as defined in the following claims.

What is claimed is:

1. A system for control of emotional action expression comprising:
an emotion engine for creating an emotion according to information provided from a plurality of sensors;
an emotional action expression/actuation control unit for detecting an emotion platform profile and an emotion property from the created emotion and determining the action expression corresponding to the created emotion to control a target actuator; and
a control unit for controlling the motion of the target actuator under the control of the emotional action expression/actuation control unit.

2. The system of claim 1, further comprising an external management unit having a tool for carrying out monitoring and debugging of the emotional action expression through communication with the emotional action expression/actuation control unit, a tool for creating and editing a motion and an action, and a tool for setting environment or managing resources.

3. The system of claim 1, further comprising a management resource unit having an action map according to the emotion, log data, and an environment data resource file.

4. The system of claim 1, wherein the emotional action expression/actuation control unit comprises:
a logger for storing input/output information and an input/output state thereof;
an action expresser for determining the action expression according to the input emotion;
a mapper for providing a mapping function based on the action map;
an environment setter for loading and referring to environment setting information;
an actuator controller for controlling the actuator depending on the action expression based on the emotion; and
a communicator for supporting a communication environment with the external management unit.

5. The system of claim 4, wherein the emotional action expression/actuation control unit records input log information in response to information on the emotion from the emotion engine, detects the emotion property by loading the emotion platform profile, and determines action expression according to the emotion information through the mapper providing a mapping function based on the action map.

6. The system of claim 5, wherein the input log information includes the emotion information and time stamp information and includes a hash value for security of information.

7. The system of claim 5, wherein the emotion platform profile includes information about the actuators of the system and information about a range of a specifically drivable value and a control type of the actuators.

8. The system of claim 5, wherein the emotion property includes an emotion state, emotion intensity or emotion index information, single or complex emotion relation information, and basic emotion behavior information.

9. The system of claim 5, wherein the action map includes information about an emotion step depending on emotion intensity, a basic behavior according to the emotion, a human-readable action expression, and an action transition, based on a definition of an action, and the action map is created and edited in a tool program of the external management unit.

10. The system of claim 4, wherein the emotional action expression/actuation control unit comprises:
a data receiver for receiving the emotion information including the emotion state and the emotion intensity from the emotion engine;
a data resolver for detecting the emotion platform profile and the emotion property;
a coordinator for organically associating the action expresser and an actuator control module;
an actuator checker for initializing the actuators or checking the state of the actuators;
a target selector for selecting a target actuator of the actuators depending on the action expression;
a command analyzer for analyzing a control command and determining control type of the control command;
a resource controller for checking internal resources and calling or executing the system using the internal resources;
a control message creator for creating a control message for use of external resources; and
a message transmitter for transmitting the control message.

11. The system of claim 10, wherein the emotional action expression/actuation control unit further comprises a logger for recording output log information.

12. The system of claim 11, wherein the output log information includes the control message and time stamp information, and includes a hash value for security of information.

13. The system of claim 10, wherein the emotional action expression/actuation control unit performs a coordinator function for organic interlocking to the actuator controller controlling the actuators in correspondence to the action expression according to the emotion and performs a function for communication and information sharing with the external management unit.

14. A method for control of emotional action expression comprising:
extracting characteristic information and creating emotion information with respect to an internal or external stimulus using a plurality of sensors;
detecting an emotion platform profile and an emotion property and referring to an action map, in response to the emotion information;
determining action expression corresponding to the emotion information;
selecting a target actuator expressing the motion depending on the action expression and determining control type of the target actuator;
controlling the motion of the target actuator according to the determined control type; and
expressing the emotion provided from the emotion engine.

15. The method of claim 14, wherein determining the action expression comprises:
receiving the emotion information from the emotion engine and recording input log information; and
detecting the emotion property by loading the emotion platform profile and determining the action expression according to the emotion information based on the action map.

16. The method of claim 14, wherein expressing the emotion comprises:
initializing the actuators or checking the state of the actuators;
determining use of internal resources or external resources for control of the target actuator for expression of the emotion;
checking, upon determining the use of the internal resources, the internal resource for directly controlling of the target actuator; and
transmitting a control command to the target actuator thereby expressing the emotion pursuant to the control type.

17. The method of claim 16, wherein, upon determining the use of the external resources, expressing the emotion comprises:
creating a control message to be transmitted to an external control board; and
transmitting the control message to an external control board thereby expressing the emotion pursuant to the control type.

18. The method of claim 14, further comprising:
after expressing the emotion, controlling motion for expression of the emotion; and
recording output log information.
